(19) United States
(12) Patent Application Publication
(10) Pub. No.: US 2013/0222358 A1
(43) Pub. Date: Aug. 29, 2013

(54) PLASMA DISPLAY APPARATUS AND PLASMA DISPLAY PANEL DRIVING METHOD

(71) Applicants: Takahiko Origuchi, Osaka (JP); Hidehiko Shoji, Osaka (JP); Yuya Shiozaki, Osaka (JP); Ayuhiko Saito, Osaka (JP)

(72) Inventors: Takahiko Origuchi, Osaka (JP); Hidehiko Shoji, Osaka (JP); Yuya Shiozaki, Osaka (JP); Ayuhiko Saito, Osaka (JP)

(73) Assignee: PANASONIC CORPORATION, Osaka (JP)

(21) Appl. No.: 13/702,277

(22) PCT Filed: Jul. 29, 2011
(86) PCT No.: PCT/JP11/04311

§ 371 Date: Dec. 5, 2012

(30) Foreign Application Priority Data
Aug. 2, 2010 (JP) 2010-173353

(51) Int. Cl. G09G 3/28

(52) U.S. Cl. CPC G09G 3/28
USPC 345/212; 345/60

(57) ABSTRACT

Image display quality in the plasma display apparatus can be enhanced by allowing a stable address operation. For this purpose, the plasma display apparatus includes a scan electrode driver circuit. The scan electrode driver circuit generates driving voltages to be used in a subfield method and applies the driving voltages to scan electrodes. At the end of each sustain period, the scan electrode driver circuit performs the following operation. The scan electrodes are applied with a first ramp waveform voltage that rises from a base electric potential to a first electric potential. Subsequently, the electric potential of the scan electrodes is set to a second electric potential equal to or lower than the first electric potential. Subsequently, the scan electrodes are applied with a second ramp waveform voltage that rises from the second electric potential to a third electric potential higher than the first electric potential.

### TECHNICAL FIELD

The present invention relates to a plasma display apparatus and to a driving method for a plasma display panel that are used for a wall-mounted television or a large monitor.

### BACKGROUND ART

In a plasma display panel (hereinafter, simply referred to as “panel”), which is a typical display device, a large number of discharge cells are formed between a front substrate and a rear substrate facing each other. With the front substrate, a plurality of display electrode pairs, each formed of a scan electrode and a sustain electrode, is formed in parallel with each other on a front glass substrate. A dielectric layer and a protective layer are formed so as to cover these display electrode pairs.

With the rear substrate, a plurality of parallel data electrodes is formed on a rear glass substrate. A dielectric layer is formed so as to cover these data electrodes. On the dielectric layer, a plurality of barrier ribs is formed in parallel with the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. The sealed inside discharge space is filled with a discharge gas containing xenon in a partial pressure ratio of 5%, for example. Discharge cells are formed in the parts where the display electrode pairs face the data electrodes. In the respective discharge cells of the thus structured panel, a gas discharge generates ultraviolet rays, and the ultraviolet rays excite the phosphors of red color (R), green color (G), and blue color (B) such that the phosphors of the respective colors emit light for color image display.

A typically used method for driving the panel is a subfield method. In the subfield method, one field is divided into a plurality of subfields and light emission or no light emission in each discharge cell is controlled in each subfield. Thus, gradations are displayed by controlling the number of light emissions in one field.

Each subfield has an initializing period, an address period, and a sustain period.

In the initializing periods, initializing waveforms are applied to the respective scan electrodes so as to cause an initializing discharge in the respective discharge cells. This operation forms wall charge necessary for the succeeding address operation in the respective discharge cells, and generates priming particles (excitation particles for generating a discharge) for generating a stable address discharge.

In the address periods, a scan pulse is applied sequentially to the scan electrodes, and an address pulse is applied selectively to the data electrodes in response to the signals of an image to be displayed. This operation causes an address discharge between the scan electrodes and the data electrodes in the discharge cells to be lit and forms wall charge in the discharge cells (hereinafter, this operation being also referred to as “addressing”).

In each sustain period, a number of sustain pulses predetermined for the subfield are applied alternately to the display electrode pairs, each formed of a scan electrode and a sustain electrode. Thereby, a sustain discharge occurs in the discharge cells having undergone the address discharge, and the phosphor layers of the discharge cells emit light. (Hereinafter, causing a discharge cell to be lit by a sustain discharge is also referred to as “lighting”, and causing a discharge cell not to be lit as “non-lighting”.) Thus, the respective discharge cells are lit at luminances corresponding to the luminance weight predetermined for each subfield. In this manner, the respective discharge cells of the panel are lit at luminances corresponding to the gradation values of the image signals for image display in the image display area of the panel.

One of the important factors in enhancing the quality of an image displayed on the panel is to enhance contrast. As one of the methods for driving a panel by a subfield method, the following driving method is disclosed. In this method, the contrast of the image displayed on the panel is enhanced by minimizing the light emission unrelated to gradation display.

In this driving method, an initializing operation for causing an initializing discharge in all the discharge cells in the image display area of the panel is performed in the initializing period of one subfield among a plurality of subfields forming one field. In the initializing periods of the other subfields, the following initializing operation is performed. That is, an initializing discharge is caused selectively in the discharge cells having undergone a sustain discharge in the sustain period of the immediately preceding subfield.

Hereinafter, the initializing operation for causing an initializing discharge in all the discharge cells in the image display area regardless of the operation in the immediately preceding subfield is referred to as “all-cell initializing operation”. The initializing operation for causing an initializing discharge selectively in the discharge cells having undergone a sustain discharge in the sustain period of the immediately preceding subfield is referred to as “selective initializing operation”.

The luminance of a region displaying black where no sustain discharge occurs (hereinafter, simply referred to as “luminance of black level”) changes with the light emission caused regardless of the magnitudes of gradation values. Such light emission includes a light emission caused by an initializing discharge. In the above driving method, the light emission in the region displaying black is only the weak light emission occurring when an initializing operation for causing an initializing discharge in all the discharge cells is performed. This reduces the luminance of black level of an image displayed on the panel, thus allowing display of an image of high contrast on the panel (see Patent Literature 1, for example).

Another disclosed driving method can enhance the visibility of black by reducing the luminance of black level of an image displayed on the panel in the following manner (see Patent Literature 2, for example). An initializing period is set such that the following initializing waveform is applied to the scan electrodes so as to cause an initializing discharge in the discharge cells having undergone a sustain discharge in the sustain period of the immediately preceding subfield. The initializing waveform includes two parts: a rising part having a gentle ramp portion where the voltage gradually increases, and a falling part having a gentle ramp portion where the voltage gradually decreases. Further, immediately before any initializing period in one field, a period where a weak discharge occurs between the sustain electrodes and scan electrodes in all the discharge cells is set.

With a recent increase in the definition of the panel, the discharge cells are being further miniaturized and the following facts are verified for the miniaturized discharge cells. The wall charge formed in a discharge cell by the initializing discharge is likely to change under the influence of the address discharge and the sustain discharge caused in the adjacent discharge cells.

That is, when a discharge cell undergoing no sustain discharge is adjacent to a discharge cell undergoing a sustain discharge, the wall charge of the discharge cell undergoing no sustain discharge is likely to change under the influence of the sustain discharge occurring in the adjacent discharge cells. It is also verified that in the subfield where a large number of sustain pulses are generated in the sustain period, the influence is considerable.

When unnecessary wall charge excessively accumulates in a discharge cell, an address discharge, for example, can erroneously occur in the discharge cell where no address discharge is to be caused. Hereinafter, such an erroneously occurring discharge is also referred to as “false discharge”. This false discharge is a cause of degradation of image display quality in the plasma display apparatus.

Since the screen size and definition of the panel have been increased in a plasma display apparatus, further enhancing the image display quality is in demand.

### CITATION LIST

### Patent Literature

### PTL1

Japanese Patent Unexamined Publication No. 2000-242224

### PTL2

Japanese Patent Unexamined Publication No. 2004-37883

### SUMMARY OF THE INVENTION

A plasma display apparatus of the present invention includes the following elements:

a panel including a plurality of scan electrodes; and

a scan electrode driver circuit for generating driving voltages to be used in a subfield method and applying the driving voltages to the scan electrodes.

The subfield method displays gradations in a manner such that a plurality of subfields, each having an initializing period, an address period, and a sustain period, is set in one field. At the end of each sustain period, the scan electrode driver circuit applies a first ramp waveform voltage, rising from a base electric potential to a first electric potential, to the scan electrodes, subsequently sets the electric potential of the scan electrodes to a second electric potential equal to or lower than the first electric potential, and subsequently applies a second ramp waveform voltage, rising from the second electric potential to a third electric potential higher than the first electric potential, to the scan electrodes.

Thus, even when the discharge start voltages in a first erasing discharge differ and thus the amounts of discharge in the first erasing discharge vary with each other, the occurrence of a second erasing discharge can substantially equalize the total amounts of discharge in the first erasing discharge and the second erasing discharge. Therefore, even in a panel having discharge cells miniaturized in response to higher definition, the amounts of discharge in the erasing discharge in the respective discharge cells can be substantially equalized to each other. This can stabilize the initializing operation and the address operation after the erasing operations.

In the plasma display apparatus of the present invention, after the first ramp waveform voltage has reached the first electric potential, the scan electrode driver circuit may set the electric potential of the scan electrodes to the base electric potential temporarily, thereafter change the electric potential of the scan electrodes from the base electric potential to the second electric potential, and subsequently apply the second ramp waveform voltage, rising from the second electric potential to the third electric potential, to the scan electrodes.

A driving method for a panel of the present invention drives a panel including a plurality of scan electrodes by a subfield method. The subfield method displays gradations in a manner such that a plurality of subfields, each having an initializing period, an address period, and a sustain period, is set in one field. At the end of each sustain period, the scan electrodes are applied with a first ramp waveform voltage that rises from a base electric potential to a first electric potential. Subsequently, the electric potential of the scan electrodes is set to a second electric potential equal to or lower than the first electric potential. Subsequently, the scan electrodes are applied with a second ramp waveform voltage that rises from the second electric potential to a third electric potential higher than the first electric potential.

Thus, even when the discharge start voltages in a first erasing discharge differ and thus the amounts of discharge in the first erasing discharge vary with each other, the occurrence of a second erasing discharge can substantially equalize the total amounts of discharge in the first erasing discharge and the second erasing discharge. Therefore, even in a panel having discharge cells miniaturized in response to higher definition, the amounts of discharge in the erasing discharge in the respective discharge cells can be substantially equalized to each other. This can stabilize the initializing operation and the address operation after the erasing operations.

In the driving method for the panel of the present invention, after the first ramp waveform voltage has reached the first electric potential, the electric potential of the scan electrodes may be set to the base electric potential temporarily. Thereafter, the electric potential of the scan electrodes may be changed from the base electric potential to the second electric potential. Sequentially, the scan electrodes may be applied with the second ramp waveform voltage that rises from the second electric potential to the third electric potential.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a waveform chart showing an example of driving voltage waveforms applied to the respective electrodes of the panel for use in the plasma display apparatus in accordance with the exemplary embodiment.

FIG. 4 is a circuit block diagram of the plasma display apparatus in accordance with the exemplary embodiment.

FIG. 5 is a circuit diagram showing a configuration example of a scan electrode driver circuit in accordance with the exemplary embodiment.

FIG. 6 is a timing chart for explaining an example of an operation of a scan electrode driver circuit in a last part of a sustain period and a selective initializing period in accordance with the exemplary embodiment.

FIG. 7 is a characteristic chart showing the relation between voltage Vr2 and an address pulse (amplitude) in accordance with the exemplary embodiment.

FIG. 8 is a characteristic chart showing the relation between voltage Vr2 and a luminance of black level in accordance with the exemplary embodiment.

### DESCRIPTION OF EMBODIMENTS

Hereinafter, a description is provided for a plasma display apparatus in accordance with the exemplary embodiment of the present invention with reference to the accompanying drawings.

### Exemplary Embodiment

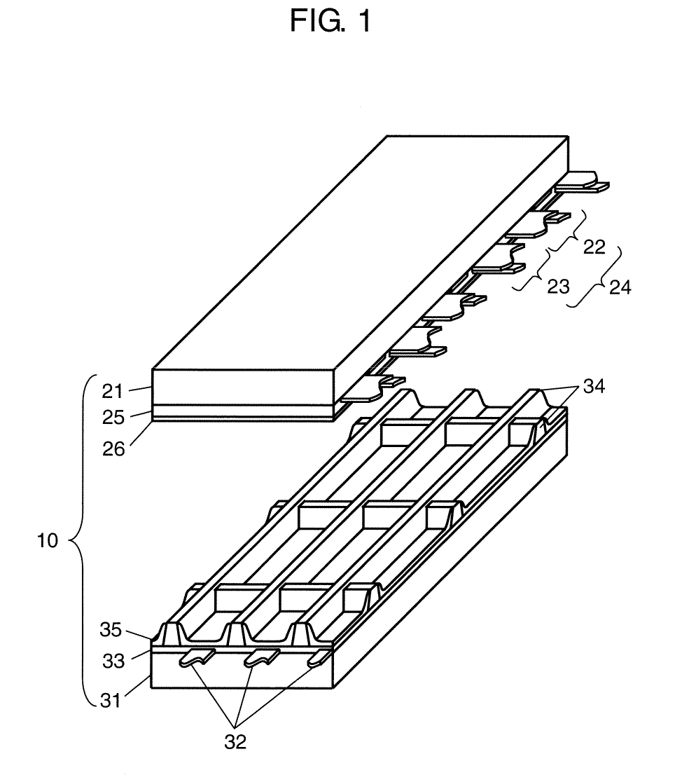

FIG. 1 is an exploded perspective view showing a structure of panel 10 for use in the plasma display apparatus in accordance with the exemplary embodiment of the present invention. A plurality of display electrode pairs 24, each formed of scan electrode 22 and sustain electrode 23, is formed on glass front substrate 21. Dielectric layer 25 is formed so as to cover scan electrodes 22 and sustain electrodes 23. Protective layer 26 is formed over dielectric layer 25.

In order to lower a discharge start voltage in each discharge cell, protective layer 26 is formed of a material predominantly composed of magnesium oxide (MgO). MgO has proven performance as a panel material, and has a large secondary electron emission coefficient and excellent durability when neon (Ne)-xenon (Xe) gas is sealed.

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 each for emitting light of red color (R), green color (G), or blue color (B) are disposed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas. In this exemplary embodiment, in order to enhance the emission efficiency in the discharge cells, a discharge gas having a xenon partial pressure of approximately 10% is used.

The discharge space is partitioned into a plurality of compartments by barrier ribs 34. Discharge cells are formed in the intersecting parts of display electrode pairs 24 and data electrodes 32. Thus, a plurality of discharge cells is formed in panel 10.

In these discharge cells, a discharge occurs so as to cause phosphor layers 35 of the discharge cells to emit light (to be lit). Thus, a color image is displayed on panel 10.

In panel 10, three consecutive discharge cells arranged in the extending direction of display electrode pair 24, i.e. a discharge cell for emitting light of red color (R), a discharge cell for emitting light of green color (G), and a discharge cell for emitting light of blue color (B), form one pixel.

The structure of panel 10 is not limited to the above. The panel may include barrier ribs in a stripe pattern, for example, arranged only in the vertical direction (column direction). The mixture ratio of the discharge gas is not limited to the above numerical value, and other mixture ratios may be used.

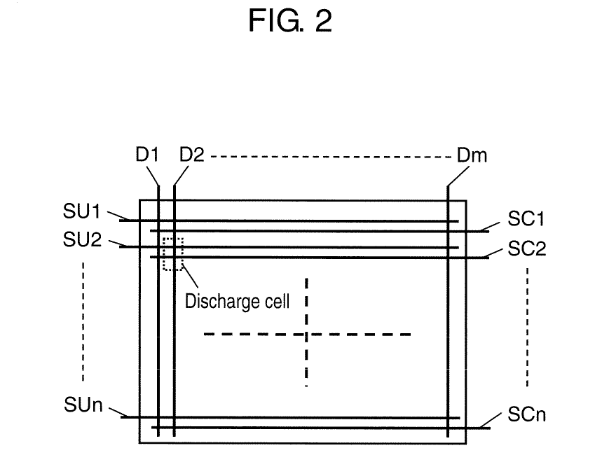

FIG. 2 is an electrode array diagram of panel 10 for use in the plasma display apparatus in accordance with the exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) extending in the horizontal direction (line direction), and m data electrode D1-data electrode Dm (data electrodes 32 in FIG. 1) extending in the vertical direction (column direction).

A discharge cell is formed in the part where a pair of scan electrode SCi (i=1−n) and sustain electrode SUi intersects one data electrode Dk (k=1−m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

Next, driving voltage waveforms for driving panel 10 and the operation thereof are outlined.

The plasma display apparatus of this exemplary embodiment displays gradations on panel 10 by a subfield method. In the subfield method, one field is divided into a plurality of subfields along a temporal axis, and a luminance weight is set for each subfield. Each subfield has an initializing period, an address period, and a sustain period.

In the initializing periods, an initializing operation is performed so as to cause an initializing discharge in the discharge cells and form wall charge necessary for the address discharge in the succeeding address period on the respective electrodes. In this exemplary embodiment, one of “all-cell initializing operation” and “selective initializing operation” is performed in the initializing period. The all-cell initializing operation is an initializing operation for causing an initializing discharge in all the discharge cells in the image display area regardless of the operation in the immediately preceding subfield. The selective initializing operation is an initializing operation for causing an initializing discharge only in the discharge cells having undergone a sustain discharge in the sustain period of the immediately preceding subfield.

For instance, an “all-cell initializing operation” is performed in the initializing period of the first subfield (subfield SF1) of one field, and a selective initializing operation is performed in the initializing periods of the other subfields. In this case, an all-cell initializing waveform for performing an all-cell initializing operation is applied to the discharge cells in the initializing period of the first subfield (subfield SF1) of one field. In the initializing periods of the other subfields, a selective initializing waveform for performing a selective initializing operation is applied to the discharge cells. This operation can minimize the light emission unrelated to gradation display and enhance the contrast ratio of the image displayed on panel 10.

Hereinafter, the initializing period during which an all-cell initializing operation is performed is referred to as “all-cell initializing period”, and the subfield including an all-cell initializing period is referred to as “all-cell initializing subfield”. The initializing period during which a selective initializing operation is performed is referred to as “selective initializing period”, and the subfield including a selective initializing period is referred to as “selective initializing subfield”.

In each address period, light emission and no light emission in the respective discharge cells are controlled in each subfield by causing an address discharge in the discharge cells to be lit.

In each sustain period, sustain pulses equal in number to the luminance weight of the subfield multiplied by a predetermined luminance magnification are applied to each display electrode pair 24. Thus, an image is displayed on panel 10 by controlling light emission and no light emission in each discharge cell in each subfield.

The luminance weight represents a ratio of the magnitude of luminance displayed in each subfield. In the sustain period of each subfield, sustain pulses corresponding in number to the luminance weight are generated. For example, the luminance of the light emission in the subfield having the luminance weight “8” is approximately eight times as high as that in the subfield having the luminance weight “1”, and is approximately four times as high as that in the subfield having the luminance weight “2”. Thus, by selectively causing light emission in the respective subfields in combination in response to image signals, various gradations and an image can be displayed on panel 10.

In this exemplary embodiment, a description is provided for an example where one field is formed of eight subfields, i.e. subfield SF1 through subfield SF8, and the respective subfields, i.e. subfield SF1 through subfield SF8, have luminance weights of 1, 2, 4, 8, 16, 32, 64, and 128.

In this exemplary embodiment, subfield SF1 is an all-cell initializing subfield, and subfield SF2 through subfield SF8 are selective initializing subfields. Thus, the light emission unrelated to image display is only the light emission caused by the discharge in the all-cell initializing operation in subfield SF1. Therefore, the luminance of black level, i.e. the luminance of a region displaying black where no sustain discharge occurs, is determined only by the weak light emission in the all-cell initializing operation. Thus, an image of high contrast can be displayed on panel 10.

However, in this exemplary embodiment, the number of subfields and the luminance weight of each subfield are not limited to the above values. The subfield structure may be switched in response to an image signal, for example.

In this exemplary embodiment, consecutive two up-ramp waveform voltages are generated at the end of each sustain period. This stabilizes the initializing operation in the initializing period and the address operation in the address period in the succeeding subfield. Hereinafter, a description is provided for the outline of a driving voltage waveform first and a configuration of a driver circuit next.

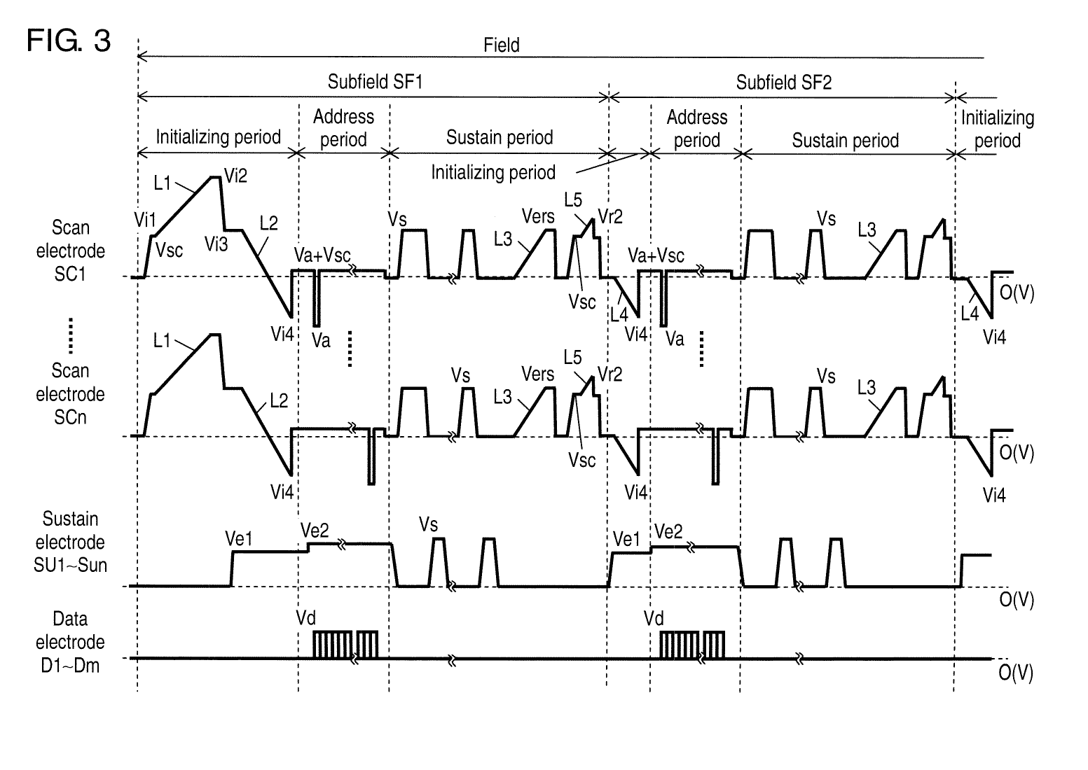

FIG. 3 is a waveform chart showing an example of driving voltage waveforms applied to the respective electrodes of panel 10 for use in the plasma display apparatus in accordance with the exemplary embodiment of the present invention. FIG. 3 shows driving voltage waveforms applied to the following electrodes: scan electrode SC1 to undergo an address operation first in the address periods; scan electrode SCn to undergo an address operation last in the address periods (e.g. scan electrode SC1080); sustain electrode SU1-sustain electrode SUn; and data electrode D1-data electrode Dm.

With reference to FIG. 3, a description is provided for driving voltage waveforms applied to panel 10 in two subfields as an example. These two subfields are “subfield SF1”, where an all-cell initializing operation is performed in the initializing period, and “subfield SF2”, where a selective initializing operation is performed in the initializing period.

Although subfield SF3 through subfield SF8 are not shown, in this exemplary embodiment, the respective subfields except subfield SF1 are selective initializing subfields. In the respective periods, substantially the same driving voltage waveforms are generated except for the numbers of sustain pulses. Therefore, between subfield SF1 and subfield SF2 through subfield SF8, the waveform shapes of the driving voltages applied to scan electrodes 22 in the initializing periods are different.

Scan electrode SCi, sustain electrode SUi, and data electrode Dk in the following description are the electrodes selected among the respective electrodes, based on subfield data (data representing light emission and no light emission in each subfield).

First, a description is provided for subfield SF1, i.e. an all-cell initializing subfield.

In the first half of the initializing period of subfield SF1, voltage 0 (V) is applied to each of data electrode D1-data electrode Dm and sustain electrode SU1-sustain electrode SUn. After voltage 0 (V) is applied to scan electrode SC1-scan electrode SCn, these electrodes are applied with voltage Vi1 and a ramp waveform voltage (hereinafter, being referred to as “up-ramp voltage L1”) rising from voltage Vi1 toward voltage V12 gently (with a gradient of approximately 1.3 V/μsec, for example). At this time, voltage Vi1 is set to a voltage lower than a discharge start voltage with respect to sustain electrode SU1-sustain electrode SUn. Voltage V12 is set to a voltage exceeding the discharge start voltage with respect to sustain electrode SU1-sustain electrode SUn.

While up-ramp voltage L1 is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn, and positive wall voltage accumulates on sustain electrode SU1-sustain electrode SUn, and data electrode D1-data electrode Dm intersecting scan electrode SC1-scan electrode SCn. This wall voltage on the electrodes means voltage that is generated by the wall charge accumulated on dielectric layer 25 covering the electrodes, protective layer 26, phosphor layers 35, or the like.

In the second half of the initializing period of subfield SF1, the voltage applied to scan electrode SC1-scan electrode SCn is lowered from voltage V12 to voltage V13, which is lower than voltage V12. Positive voltage Ve1 is applied to sustain electrode SU1-sustain electrode SUn, and voltage 0 (V) is applied to data electrode D1-data electrode Dm. Next, scan electrode SC1-scan electrode SCn are applied with a ramp waveform voltage (hereinafter referred to as “down-ramp voltage L2”) falling from voltage V13 toward negative voltage V14 gently (with a gradient of approximately −2.5 V/μsec, for example). At this time, voltageVi3 is set to a voltage lower than the discharge start voltage with respect to sustain electrode SC1-sustain electrode SCn. VoltageVi4 is set to a voltage exceeding the discharge start voltage with respect to sustain electrode SC1-sustain electrode SCn.

While down-ramp voltage L2 is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn and the positive wall voltage on sustain electrode SU1-sustain electrode SUn, and adjusts the positive wall voltage on data electrode D1-data electrode Dm intersecting scan electrode SC1-scan electrode SCn to a value appropriate for the address operation in the address period.

The above voltage waveforms are all-cell initializing waveforms for causing an initializing discharge in the discharge cells regardless of the operation in the immediately preceding subfield. The operation of applying the all-cell initializing waveform to scan electrodes 22 is the all-cell initializing operation.

In this manner, the all-cell initializing operation in subfield SF1, i.e. an all-cell initializing subfield, is completed.

In the subsequent address period, a scan pulse is sequentially applied to scan electrode SC1-scan electrode SCn. An address pulse is applied to data electrode Dk corresponding to a discharge cell to be lit among data electrode D1-data electrode Dm. Thus, an address discharge is selectively caused only in the discharge cells to be lit so as to form wall charge necessary for generating a sustain discharge in the succeeding sustain period. Hereinafter, these operations are also referred to as “address operation”.

In the address period of subfield SF1, voltage Ve2 is applied to sustain electrode SU1-sustain electrode SUn, and voltage Vcc (Vcc=Va+Vsc, for example) is applied to scan electrode SC1-scan electrode SCn.

Next, a scan pulse at negative voltage Va is applied to scan electrode SC1 in the first position from the top (first line). Further, an address pulse at positive voltage Vd is applied to data electrode Dk of a discharge cell to be lit in the first line among data electrode D1-data electrode Dm.

The voltage difference in the intersecting part of data electrode Dk and scan electrode SC1 in the discharge cell applied with the address pulse at voltage Vd is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltageVe2−voltageVa). At this time, setting voltage Ve2 to a voltage value slightly lower than the discharge start voltage can make the state where a discharge is likely to occur but does not actually occurs between sustain electrode SU1 and scan electrode SC1.

With this setting, a discharge occurring between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, an address operation is performed so as to cause an address discharge in the discharge cells to be lit in the first line and accumulate wall voltage on the respective electrodes. In contrast, the voltage in the intersecting parts of scan electrode SC1 and data electrodes 32 applied with no address pulse does not exceed the discharge start voltage, and thus no address discharge occurs.

The above address operation is performed on scan electrode SC2, scan electrode SC3, . . . , scan electrode SCn in this order until the operation reaches the discharge cells in the n-th line. Thus, the address period of subfield SF1 is completed. In this manner, in the address period, an address discharge is caused selectively in the discharge cells to be lit so as to form wall charge in the discharge cells.

In the succeeding sustain period, a sustain operation is performed in the following manner. Sustain pulses corresponding in number to the luminance weight of the subfield multiplied by a predetermined proportionality factor are applied alternately to scan electrodes 22 and sustain electrodes 23. Thereby, a sustain discharge is caused in the discharge cells having undergone an address discharge in the immediately preceding address period, and the discharge cells are lit.

This proportionality factor is a luminance magnification. For instance, when the luminance magnification is 2, in the sustain period of a subfield having the luminance weight “2”, four sustain pulses are applied to each of scan electrodes 22 and sustain electrodes 23. Thus, the number of sustain pulses generated in the sustain period is 8.

In the sustain period of subfield SF1, voltage 0 (V) as a base electric potential is applied to sustain electrode SU1-sustain electrode SUn, and a sustain pulse at positive voltage Vs is applied to scan electrode SC1-scan electrode SCn. In the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thereby, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses equal in number to the luminance weight multiplied by the predetermined luminance magnification are applied alternately to scan electrode SC1-scan electrode SCn and sustain electrode SU1-sustain electrode SUn. By giving a potential difference between the electrodes of display electrode pairs 24 in this manner, the sustain discharge is continued in the discharge cells having undergone the address discharge in the address period.

After the sustain pulses have been generated in the sustain period (at the end of the sustain period), a first ramp waveform voltage (hereinafter, being referred to as “erasing ramp voltage L3”) is applied to scan electrode SC1-scan electrode SCn while voltage 0 (V) is applied to sustain electrode SU1-sustain electrode SUn and data electrode D1-data electrode Dm. The first ramp waveform voltage rises from voltage 0 (V), i.e. the base electric potential, toward voltage Vers, i.e. a first electric potential, gently (with a gradient of approximately 10 V/μsec).

Voltage Vers is set to a voltage value exceeding the discharge start voltage. Thereby, a weak discharge continuously occurs between sustain electrode SUi and scan electrode SCi in the discharge cell having undergone a sustain discharge while erasing ramp voltage L3 applied to scan electrode SC1-scan electrode SCn is rising above the discharge start voltage. The charged particles generated by this weak discharge accumulate on sustain electrode SUi and scan electrode SCi so as to reduce the voltage difference between sustain electrode SUi and scan electrode SCi.

Thereby, the wall voltage on scan electrode SCi and the wall voltage on sustain electrode SUi are reduced to the difference between the voltage applied to scan electrode SCi and the discharge start voltage, e.g. the degree of (voltage Vers-discharge start voltage) while positive wall voltage is left on data electrode Dk. Hereinafter, this discharge is referred to as “erasing discharge”. The erasing discharge is a discharge for erasing a part of unnecessary wall charge in the discharge cell.

After the voltage applied to scan electrode SC1-scan electrode SCn has reached voltage Vers, the voltage applied to scan electrode SC1-scan electrode SCn is lowered to voltage 0 (V).

After voltage 0 (V) has been applied to scan electrode SC1-scan electrode SCn, voltage Vsc, i.e. a second electric potential, is applied to scan electrode SC1-scan electrode SCn. At this time, voltage Vsc is set equal to or lower than voltage Vers. With this setting, no discharge occurs in the discharge cells even when voltage Vsc is applied to scan electrode SC1-scan electrode SCn.

Next, while sustain electrode SU1-sustain electrode SUn and data electrode D1-data electrode Dm are kept at voltage 0 (V), scan electrode SC1-scan electrode SCn are applied with a second ramp waveform voltage (hereinafter, being referred to as “erasing ramp voltage L5”). Erasing ramp voltage L5 rises from voltage Vsc, i.e. the second electric potential, to voltage Vr2, i.e. a third electric potential, with a gradient equal to that of erasing ramp voltage L3 (with a gradient of approximately 10 V/μsec, for example).

Voltage Vr2 is set to a voltage value higher than voltage Vers. Thus, while erasing ramp voltage L5 applied to scan electrode SC1-scan electrode SCn is rising above voltage Vers, a weak erasing discharge continuously occurs again in the discharge cells where an erasing discharge is caused by erasing ramp voltage L3.

In this exemplary embodiment, two erasing discharges are caused by erasing ramp voltage L3 and erasing ramp voltage L5 in the discharge cells having undergone a sustain discharge. This operation can erase the wall charge in the discharge cells in a more stable manner than the structure where an erasing discharge is caused by erasing ramp voltage L3 only. Thus, even in panel 10 that includes the discharge cells miniaturized in response to higher definition, the initializing operation and the address operation after the erasing operations can be performed in a stable manner.

After the voltage applied to scan electrode SC1-scan electrode SCn has reached voltage Vr2, the voltage applied to scan electrode SC1-scan electrode SCn is lowered to voltage 0 (V). Thus, the sustain operation in the sustain period of subfield SF1 is completed.

In this manner, the driving operation in subfield SF1 is completed.

Next, a description is provided for the selective initializing subfield, using subfield SF2 as an example.

In the initializing period of subfield SF2, the selective initializing waveform is applied to all scan electrodes 22. This selective initializing waveform is a driving voltage waveform where the first half of the all-cell initializing waveform is omitted. Specifically, sustain electrode SU1-sustain electrode SUn are applied with voltage Ve1, and data electrode D1-data electrode Dm are applied with voltage 0 (V). Scan electrode SC1-scan electrode SCn are applied with down-ramp voltage L4, which falls from a voltage (e.g. voltage 0 (V)) lower than the discharge start voltage toward negative voltage V14 exceeding the discharge start voltage with a gradient equal to that of down-ramp voltage L2.

This voltage application causes a weak initializing discharge in the discharge cells having undergone a sustain discharge in the sustain period of the immediately preceding subfield (subfield SF1 in FIG. 3). This weak discharge reduces the wall voltage on scan electrode SCi and sustain electrode SUi. Since a sufficient positive wall voltage is accumulated on data electrode Dk by the sustain discharge caused in the immediately preceding sustain period, the excess part of this wall voltage is discharged and the wall voltage on data electrode Dk is adjusted so as to be appropriate for the address operation.

In contrast, in the discharge cells having undergone no sustain discharge in the sustain period of the immediately preceding subfield (subfield SF1 in FIG. 3), no initializing discharge occurs, and the wall charge at the completion of the initializing period of the immediately preceding subfield is maintained.

The above waveforms are the selective initializing waveforms for causing an initializing discharge only in the discharge cells having undergone a sustain discharge in the sustain period of the immediately preceding subfield. The operation of applying the selective initializing waveform to scan electrodes 22 is the selective initializing operation.

In this manner, the selective initializing operation in the initializing period of the selective initializing subfield is completed.

In the address period of subfield SF2, an address operation is performed so as to apply the driving voltage waveforms similar to those in the address period of subfield SF1 to the respective electrodes and accumulate wall voltage on the respective electrodes of the discharge cells to be lit.

In the sustain period of subfield SF2, similarly to the sustain period of subfield SF1, sustain pulses corresponding in number to the luminance weight are applied alternately to scan electrode SC1-scan electrode SUn and sustain electrode SU1-sustain electrode SUn. Thus, a sustain discharge is caused in the discharge cells having undergone an address discharge in the address period.

In the initializing period and the address period of subfield SF3 and each subfield thereafter, the respective electrodes are applied with the driving voltage waveforms similar to those in the initializing period and the address period of subfield SF2. In the sustain period of subfield SF3 and each subfield thereafter, the respective electrodes are applied with the driving voltage waveforms similar to those in subfield SF2 except for the number of sustain pulses.

The above description has outlined the driving voltage waveforms applied to the respective electrodes of panel 10 in this exemplary embodiment.

In this exemplary embodiment, the examples of the values of voltage applied to the respective electrodes are as follows: voltage Vi1=145 (V), voltage Vi2=360 (V), voltage Vi3=190 (V), voltage Vi4=−160 (V), voltage Ve1=125 (V), voltage Ve2=130 (V), voltage Vers=190 (V), voltage Vsc=145 (V), voltage Vs=190 (V), voltage Va=−180 (V), voltage Vd=60 (V), and voltage Vr2=255 (V). Voltage Vcc can be generated by superimposing positive voltage Vsc=145 (V) on negative voltage Va=−180 (V), that is, Vcc=Va+Vsc. In this case, voltage Vcc=−35 (V).

However, the specific numerical values of the voltages and gradients shown above are only examples. In the present invention, the respective voltage values and gradients are not limited to the above numerical values. Preferably, the respective voltage values and gradients are set optimally for the discharge characteristics of the panel, the specifications of the plasma display apparatus, or the like.

Next, a description is provided for a configuration of a plasma display apparatus in accordance with this exemplary embodiment.

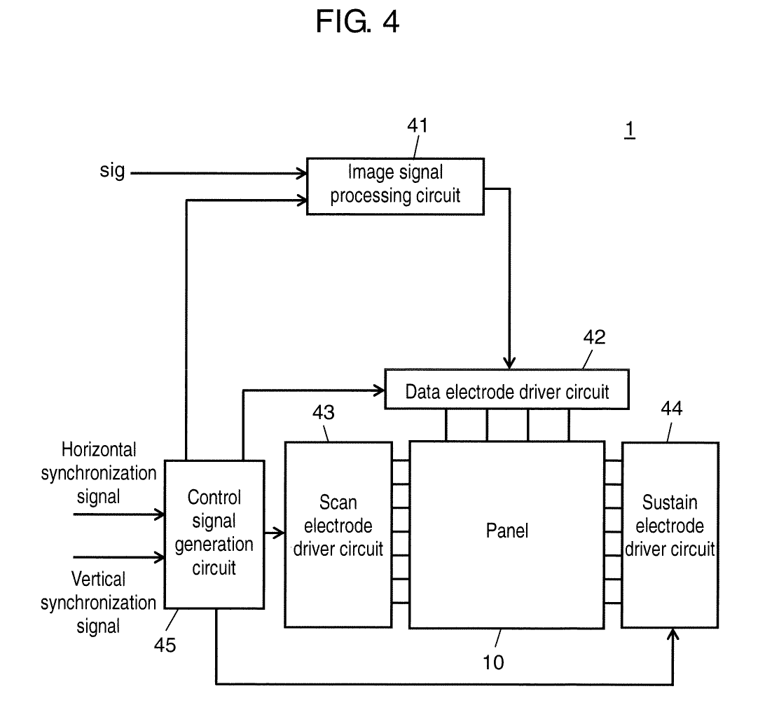

FIG. 4 is a circuit block diagram of plasma display apparatus 1 in accordance with the exemplary embodiment of the present invention. Plasma display apparatus 1 includes panel 10 and a driver circuit.

The driver circuit has the following elements:

image signal processing circuit 41;

data electrode driver circuit 42;

scan electrode driver circuit 43;

sustain electrode driver circuit 44;

control signal generation circuit 45; and

electric power supply circuits (not shown) for supplying electric power necessary for each circuit block.

Image signal processing circuit 41 allocates gradation values to the respective discharge cells, based on the number of pixels of panel 10 and input image signal sig. The image signal processing circuit converts the gradation values into subfield data representing light emission and no light emission in each subfield (data where light emission and no light emission correspond to digital signals “1” and “0”, respectively). Image signal processing circuit 41 converts the image signal in each field into subfield data representing light emission and no light emission in each subfield.

For instance, when the input image signal includes an R signal, a G signal, and a B signal, the image signal processing circuit allocates the R, G, and B gradation values to the respective discharge cells, based on the R signal, the G signal, and the B signal. When the input image signal includes a luminance signal (Y signal) and a chroma signal (C signal, WY signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into subfield data representing light emission and no light emission in each subfield.

Control signal generation circuit 45 generates various control signals for controlling the operation of each circuit block, based on horizontal synchronization signal H and vertical synchronization signal V. Then, the control signal generation circuit supplies the generated control signals to each circuit block (image signal processing circuit 41, data electrode driver circuit 42, scan electrode driver circuit 43, sustain electrode driver circuit 44, or the like).

Data electrode driver circuit 42 converts subfield data in each subfield into a signal corresponding to each of data electrode D1-data electrode Dm. Then, the data electrode driver circuit drives each of data electrode D1-data electrode Dm, based on the above signal and the control signals supplied from control signal generation circuit 45. The data electrode driver circuit generates an address pulse and applies the address pulse to each of data electrode D1-data electrode Dm in the address periods.

Scan electrode driver circuit 43 has an initializing waveform generation circuit, a sustain pulse generation circuit, and a scan pulse generation circuit (not shown in FIG. 4). The scan electrode driver circuit generates driving voltage waveforms in response to the control signals supplied from control signal generation circuit 45, and applies the waveforms to each of scan electrode SC1-scan electrode SCn.

In response to a control signal, the initializing waveform generation circuit generates initializing waveforms to be applied to scan electrode SC1-scan electrode SCn in the initializing periods.

In response to a control signal, the sustain pulse generation circuit generates a sustain pulse to be applied to scan electrode SC1-scan electrode SCn in the sustain periods.

The scan pulse generation circuit has a plurality of scan electrode driver ICs (hereinafter, simply referred to as “scan ICs”). In response to a control signal, the scan pulse generation circuit generates a scan pulse to be applied to scan electrode SC1-scan electrode SCn in the address periods.

Sustain electrode driver circuit 44 has a sustain pulse generation circuit and a circuit for generating voltage Ve1 and voltage Ve2 (not shown in FIG. 4). In response to a control signal supplied from control signal generation circuit 45, the sustain electrode driver circuit generates driving voltage waveforms and applies the waveforms to each of sustain electrode SU1-sustain electrode SUn. In the sustain periods, the sustain electrode driver circuit generates sustain pulses in response to a control signal, and applies the sustain pulses to sustain electrode SU1-sustain electrode SUn.

Next, scan electrode driver circuit 43 and the operation thereof are detailed.

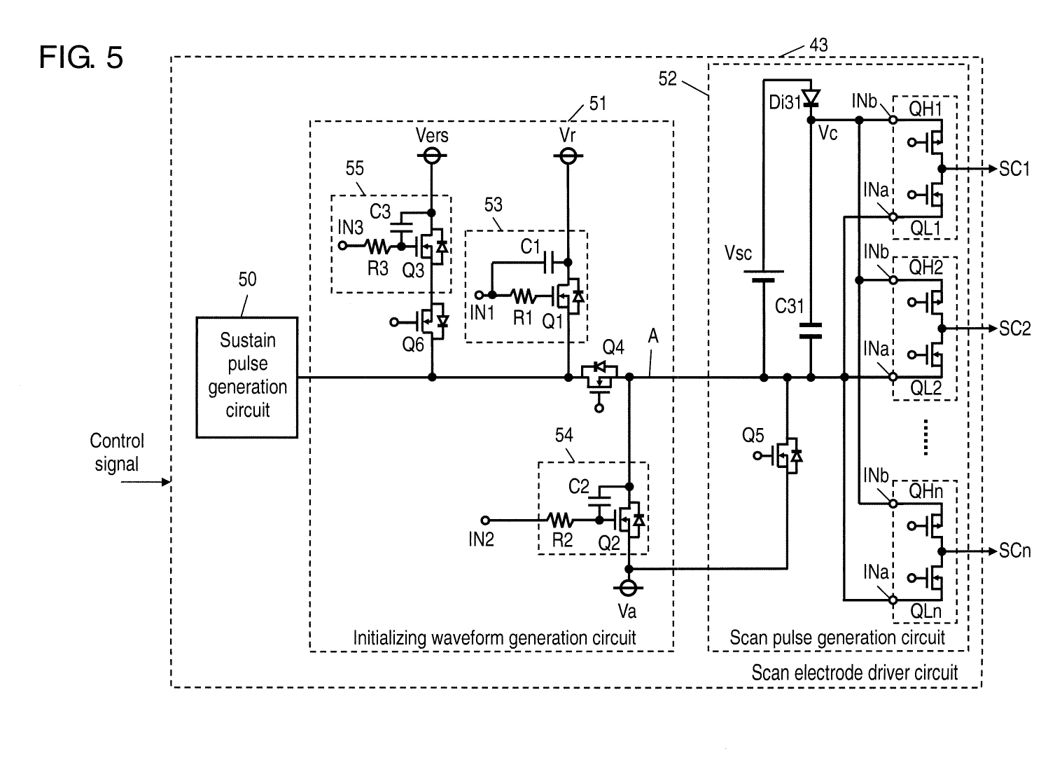

FIG. 5 is a circuit diagram showing a configuration example of scan electrode driver circuit 43 in accordance with the exemplary embodiment of the present invention.

Scan electrode driver circuit 43 has sustain pulse generation circuit 50 for generating sustain pulses, initializing waveform generation circuit 51 for generating initializing waveforms, and scan pulse generation circuit 52 for generating scan pulses. The output terminals of scan pulse generation circuit 52 are connected to respective scan electrode SC1-scan electrode SCn of panel 10.

In this exemplary embodiment, the voltage input into scan pulse generation circuit 52 is denoted as “reference electric potential A”. In the following description, the operation of turning on a switching element is denoted as “ON”, and the operation of turning off a switching element is denoted as “OFF”. The signal for setting a switching element to ON is denoted as “Hi”, and the signal for setting a switching element to OFF is denoted as “Lo”. In FIG. 5, the detailed signal paths for control signals (control signals supplied from control signal generation circuit 45) input into the respective circuits are omitted.

FIG. 5 shows a separation circuit including switching element Q4, for electrically separating sustain pulse generation circuit 50, a circuit based on voltage Vr (e.g. Miller integration circuit 53), and a circuit based on voltage Vers (e.g. Miller integration circuit 55) from a circuit based on negative voltage Va (e.g. Miller integration circuit 54) while the latter circuit is operated. The diagram also shows a separation circuit including switching element Q6, for electrically separating a circuit based on voltage Vers (e.g. Miller integration circuit 55), which is lower than voltage Vr, from a circuit based on voltage Vr (e.g. Miller integration circuit 53) while the latter circuit is operated.

Sustain pulse generation circuit 50 has a generally-used power recovery circuit (not shown) and a clamp circuit (not shown).

The power recovery circuit includes a power recovery capacitor and a resonance inductor. By causing resonance between interelectrode capacitance Cp of panel 10 and the resonance inductor, the power recovery circuit supplies the electric power stored in the power recovery capacitor to scan electrode SC1-scan electrode SCn, or recovers the electric power stored in interelectrode capacitance Cp into the power recovery capacitor.

The clamp circuit clamps scan electrode SC1-scan electrode SCn to voltage Vs or voltage 0 (V).

Sustain pulse generation circuit 50 generates sustain pulses in the following manner. The sustain pulse generation circuit switches the power recovery circuit and the clamp circuit by switching each switching element included in the circuit in response to a control signal output from control signal generation circuit 45.

Scan pulse generation circuit 52 includes switching element QH1-switching element QHn and switching element QL1-switching element QLn for applying a scan pulse to n scan electrode SC1-scan electrode SCn, respectively. One terminal of switching element QHj (j=1−n) connects to one terminal of switching element QLj. The connection part forms an output terminal of scan pulse generation circuit 52 and connects to scan electrode SCj. The other terminal of switching element QHj is input terminal INb, and the other terminal of switching element QLj is input terminal INa.

Switching element QH1-switching element QHn and switching element QL1-switching element QLn are grouped in a plurality of outputs and formed into ICs. These ICs are scan ICs.

Scan pulse generation circuit 52 includes the following elements:

switching element Q5 for connecting reference electric potential A to negative voltage Va in the address periods;

electric power supply VSC for generating voltage Vsc and superimposing voltage Vsc on reference electric potential A; and

diode D131 and capacitor C31 for applying voltage Vc where voltage Vsc is superimposed on reference electric potential A to input terminal INb. Voltage Vc is input into input terminal INb of each of switching element QH1-switching element QHn. Reference electric potential A is input into input terminal INa of each of switching element QL1-switching element QLn.

In thus configured scan pulse generation circuit 52, in the address periods, switching element Q5 is set to ON such that reference electric potential A is equal to negative voltage Va. Further, negative voltage Va is applied to input terminal INa, and voltage Vcc, i.e. voltage Va+voltage Vsc, is applied to input terminal INb.

In response to the subfield data, the following operation is performed. To scan electrode SCi to be applied with a scan pulse, a scan pulse at negative voltage Va is applied via switching element QLi by setting switching element QHi to OFF and setting switching element QLi to ON.

To scan electrode SCh (h=1-n except i) to be applied with no scan pulse, voltage Va+voltage Vsc (=voltage Vcc) is applied via switching element QHh by setting switching element QLh to OFF and setting switching element QHh to ON.

Scan pulse generation circuit 52 is controlled by control signal generation circuit 45 so as to output a voltage waveform from initializing waveform generation circuit 51 in the initializing periods and output a voltage waveform from sustain pulse generation circuit 50 in the sustain periods.

Initializing waveform generation circuit 51 includes Miller integration circuit 53, Miller integration circuit 54, and Miller integration circuit 55. FIG. 5 shows the input terminal of Miller integration circuit 53 as input terminal IN1, the input terminal of Miller integration circuit 54 as input terminal IN2, and the input terminal of Miller integration circuit 55 as input terminal IN3. Each of Miller integration circuit 53 and Miller integration circuit 55 is a ramp voltage generation circuit for generating a rising ramp waveform voltage. Miller integration circuit 54 is a ramp voltage generation circuit for generating a falling ramp waveform voltage.

Miller integration circuit 53 includes switching element Q1, capacitor C1, and resistor R1. In the all-cell initializing operation, this Miller integration circuit raises reference electric potential A of scan electrode driver circuit 43 to voltage Vr in a ramp form gently (with a gradient of 1.3 V/μsec, for example). In the all-cell initializing operation, switching element QH1-switching element QHn are set to ON, and switching element QL1-switching element QLn are set to OFF. Therefore, reference electric potential A rises from voltage 0 (V) to voltage Vr in a ramp form, and scan electrode SC1-scan electrode SCn are applied with a voltage where voltage Vsc is superimposed on reference electric potential A. Thus, in the all-cell initializing operation, up-ramp voltage L1 is generated and applied to scan electrode SC1-scan electrode SCn. This up-ramp voltage rises from voltage Vsc (voltage Vi1=voltage Vsc in this exemplary embodiment) to voltage Vsc+voltage Vr (voltage V12=voltage Vsc+voltage Vr in this exemplary embodiment).

Miller integration circuit 55 includes switching element Q3, capacitor C3, and resistor R3. At the end of each sustain period, this Miller integration circuit raises reference electric potential A from voltage 0 (V) to voltage Vers with a gradient (of 10 V/μsec, for example) steeper than that of up-ramp voltage L1 so as to generate erasing ramp voltage L3, and applies the voltage to scan electrode SC1-scan electrode SCn. Miller integration circuit 55 also generates erasing ramp voltage L5. In this exemplary embodiment, in the period during which erasing ramp voltage L5 is generated, switching element QH1-switching element QHn are set to ON, and switching element QL1-switching element QLn are set to OFF. Therefore, during that period, scan electrode SC1-scan electrode SCn are applied with a voltage where voltage Vsc is superimposed on the ramp waveform voltage raised by Miller integration circuit 55 in a ramp form. Thus, scan electrode driver circuit 43 generates erasing ramp voltage L5 and applies the voltage to scan electrode SC1-scan electrode SCn.

Miller integration circuit 54 includes switching element Q2, capacitor C2, and resistor R2. In the initializing operations, this Miller integration circuit lowers reference electric potential A from voltage 0 (V) to voltage V14 in a ramp form gently (with a gradient of −2.5 V/μsec, for example) so as to generate down-ramp voltage L2 and down-ramp voltage L4, and applies the voltages to scan electrode SC1-scan electrode SCn.

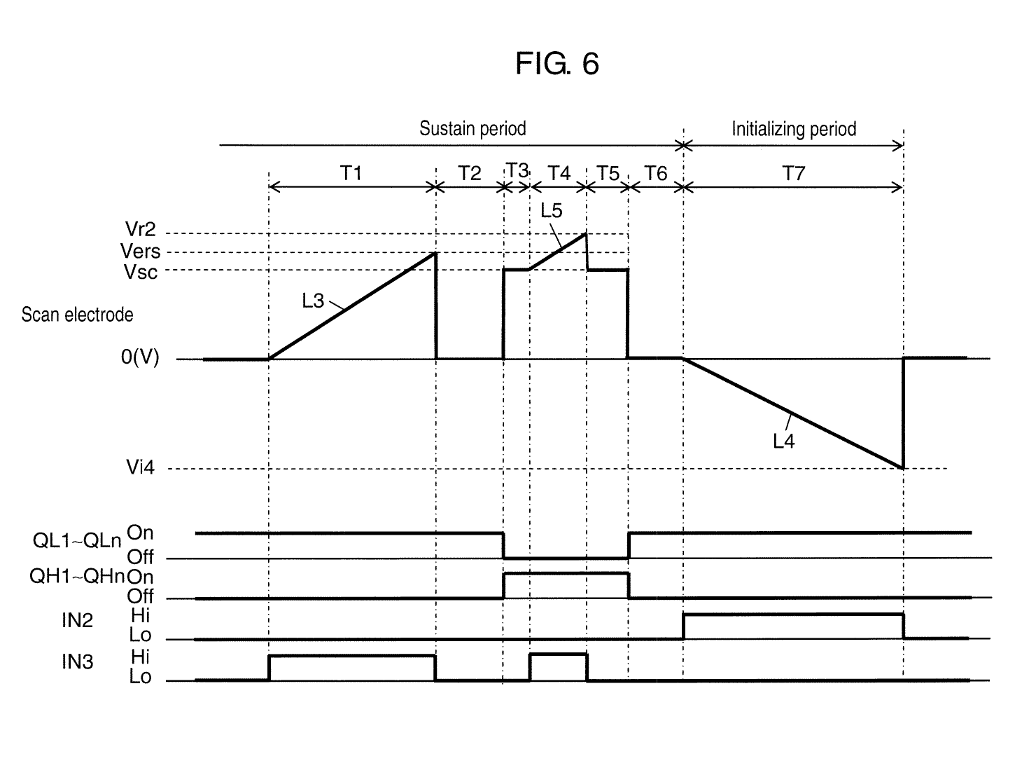

Next, a description is provided for the operation of generating erasing ramp voltage L3 and erasing ramp voltage L5 in the last part of each sustain period and generating down-ramp voltage L4 in the selective initializing period with reference to FIG. 6.

FIG. 6 is a timing chart for explaining an example of an operation of scan electrode driver circuit 43 in the last part of a sustain period and a selective initializing period in accordance with the exemplary embodiment of the present invention.

In FIG. 6, a description is provided for six sub-periods, i.e. sub-period T1 through sub-period T6, made by dividing the last part of the sustain period, together with the selective initializing period as sub-period T7. In the following description, voltage Vers is equal to voltage Vs, voltage Vsc is lower than voltage Vers, voltage Vr2 is higher than voltage Vers, and voltage V14 is equal to negative voltage Va. In the chart, a signal for setting a switching element to ON is denoted as “Hi”, and a signal for setting a switching element to OFF as “Lo”.

FIG. 6 shows an example where voltage Vsc is set to a voltage value lower than voltage Vers, and voltage Vr2 is set to a voltage value higher than voltage Vers. In this exemplary embodiment, the respective voltage values are set such that voltage Vscvoltage≦Vers<voltage Vr2. That is, the second electric potential is set to an electric potential equal to or lower than the first electric potential, and the third electric potential is set to an electric potential higher than the first electric potential.

Hereinafter, a description is provided for erasing ramp voltage L3 and erasing ramp voltage L5 in the last part of a sustain period first, and down-ramp voltage L4 in a selective initializing period next. Generation of sustain pulses has been completed before sub-period T1.

Before sub-period T1, the clamp circuit of sustain pulse generation circuit 50 sets reference electric potential A to voltage 0 (V). Next, switching element QH1-switching element QHn are set to OFF and switching element QL1-switching element QLn are set to ON. Thereby, reference electric potential A, i.e. voltage 0 (V), is applied to scan electrode SC1-scan electrode SCn.

### (Sub-Period T1)

In sub-period T1, switching element QH1-switching element QHn are kept to OFF and switching element QL1-switching element QLn are kept to ON.

Though not shown, switching element Q6 is set to ON so as to electrically connect Miller integration circuit 55 to reference electric potential A. The respective switching elements in sustain pulse generation circuit 50 are set to OFF so as to electrically separate sustain pulse generation circuit 50 from Miller integration circuit 55.

Next, input terminal IN3 of Miller integration circuit 55 is set to “Hi”. Specifically, a predetermined constant current is input into input terminal IN3. Then, a constant current flows toward capacitor C3, and the source voltage of switching element Q3 starts to rise in a ramp form. Thus, reference electric potential A rises from voltage 0 (V) in a ramp form, and the output voltage of scan electrode driver circuit 43 rises in a ramp form. This voltage rise continues while input terminal IN3 is at “Hi” or until reference electric potential A reaches voltage Vers.

At this time, the constant current to be input into input terminal IN3 is generated such that the gradient of the ramp waveform voltage is at a desired value (10 V/μsec, for example). Thus, erasing ramp voltage L3, which rises from voltage 0 (V) toward voltage Vers, is generated and applied to scan electrode SC1-scan electrode SCn.

Voltage Vers is set to a voltage value exceeding the discharge start voltage. Thereby, the voltage difference between sustain electrode SUi and scan electrode SCi in a discharge cell having undergone the sustain discharge exceeds the discharge start voltage while erasing ramp voltage L3 applied to scan electrode SC1-scan electrode SCn is rising. Thus, a weak erasing discharge occurs between scan electrode SCi and sustain electrode SUi. This erasing discharge continuously occurs while erasing ramp voltage L3 is rising.

The discharge caused by erasing ramp voltage L3 in this exemplary embodiment is a first erasing discharge.

Though not shown in FIG. 6, because data electrode D1-data electrode Dm are kept at 0 (V), positive wall voltage is formed on data electrode Dk corresponding to a discharge cell having undergone the erasing discharge.

In a discharge cell where the discharge start voltage is relatively low, a discharge starts at a relatively earlier time in sub-period T1. In a discharge cell where the discharge start voltage is relatively high, a discharge starts at a relatively later time in sub-period T1. Thus, in consideration of such variations in discharge start voltage, sub-period T1, voltage Vers, gradient of erasing ramp voltage L3, or the like is set to a numerical value at which the erasing discharge occurs even in a discharge cell where the discharge start voltage is relatively high.

Voltage Vers may be a voltage equal to or higher than voltage Vs, or a voltage lower than voltage Vs.

### (Sub-Period T2)

After erasing ramp voltage L3 has reached voltage Vers, input terminal IN3 is set to “Lo”. Specifically, the input of the constant current into input terminal IN3 is stopped. Thus, the operation of Miller integration circuit 55 is stopped.

In sub-period T2, switching element QH1-switching element QHn, and switching element QL1-switching element QLn are kept in a state same as that of sub-period T1. Next, though not shown, the clamp circuit of sustain pulse generation circuit 50 sets reference electric potential A to voltage 0 (V). Then, the voltage of scan electrode SC1-scan electrode SCn falls to voltage 0 (V) as the base electric potential.

Thus, the erasing discharge caused by erasing ramp voltage L3 in sub-period T1 stops temporarily.

### (Sub-Period T3)

In sub-period T3, while reference electric potential A is kept at voltage 0 (V) by the clamp circuit of sustain pulse generation circuit 50, switching element QH1-switching element QHn are set to ON and switching element QL1-switching element QLn are set to OFF. With this operation, the voltage where voltage Vsc is superimposed on reference electric potential A is applied to scan electrode SC1-scan electrode SCn. At this time, since reference electric potential A is voltage 0 (V), voltage Vsc is applied to scan electrode SC1-scan electrode SCn.

In this exemplary embodiment, voltage Vsc is set to a voltage value equal to or lower than voltage Vers. Therefore, even in the discharge cells where an erasing discharge is caused by erasing ramp voltage L3, no discharge occurs in sub-period T3.

### (Sub-Period T4)

In sub-period T4, switching element QH1-switching element QHn are kept to ON and switching element QL1-switching element QLn are kept to OFF.

Though not shown, switching element Q6 is set to ON so as to electrically connect Miller integration circuit 55 to reference electric potential A. The respective switching elements of sustain pulse generation circuit 50 are set to OFF so as to electrically separate sustain pulse generation circuit 50 from Miller integration circuit 55.

Next, input terminal IN3 of Miller integration circuit 55 is set to “Hi”. Specifically, a predetermined constant current is input into input terminal IN3. Then, a constant current flows toward capacitor C3, and the source voltage of switching element Q3 rises in a ramp form, Thus, reference electric potential A rises from voltage 0 (V) in a ramp form. At this time, the constant current to be input into input terminal IN3 is generated such that the gradient of the ramp waveform voltage is at a desired value (10 V/μsec, for example). Similarly to the description of sub-period T1, this voltage rise continues while input terminal IN3 is at “Hi” or until reference electric potential A reaches voltage Vers.

In sub-period T4, the output voltage of scan electrode driver circuit 43 is a voltage where voltage Vsc is superimposed on reference electric potential A. Thus, a ramp waveform voltage that rises from voltage Vsc with a gradient equal to that of erasing ramp voltage L3, for example, is output from scan electrode driver circuit 43.

In this manner, in sub-period T4, scan electrode driver circuit 43 generates erasing ramp voltage L5 that rises from voltage Vsc toward voltage Vr2, and applies the voltage to scan electrode SC1-scan electrode SCn.

Voltage Vr2 is set to a voltage value higher than voltage Vers. With this setting, while erasing ramp voltage L5 applied to scan electrode SC1-scan electrode SCn is rising above voltage Vers, the voltage difference between sustain electrode SUi and scan electrode SCi exceeds the discharge start voltage in a discharge cell where an erasing discharge is caused by erasing ramp voltage L3. This causes a weak erasing discharge again in the discharge cells where an erasing discharge is caused by erasing ramp voltage L3.

That is, in this exemplary embodiment, the discharge caused by erasing ramp voltage L5 is a second erasing discharge.

The inventor of the present invention has experimentally verified the following facts. In a discharge cell where the amount of discharge (duration of discharge) in the erasing discharge caused by erasing ramp voltage L3 (the first erasing discharge) is relatively large, the discharge start voltage of the second erasing discharge is relatively high. In a discharge cell where the amount of discharge in the first erasing discharge is relatively small, the discharge start voltage of the second erasing discharge is relatively low.

That is, the discharge amount in the second erasing discharge varies with the discharge amount in the first erasing discharge. In a discharge cell where the discharge amount in the first erasing discharge is relatively large, the second erasing discharge starts at the timing later than that in a discharge cell where the discharge amount in the first erasing discharge is relatively small.

The reason is considered as follows. In a discharge cell where the discharge amount in the first erasing discharge is relatively large, the amount of wall charge erased by the erasing discharge is larger than that in a discharge cell where the discharge amount in the first erasing discharge is relatively small. As a result, the discharge start voltage of the second erasing discharge becomes relatively high.

Thus, in a discharge cell where the discharge start voltage of the first erasing discharge is relatively high, the discharge amount in the first erasing discharge is relatively small. As a result, the discharge amount in the second erasing discharge becomes relatively large. Inversely, in a discharge cell where the discharge start voltage of the first erasing discharge is relatively low, the discharge amount in the first erasing discharge is relatively large. As a result, the discharge amount in the second erasing discharge becomes relatively small.

That is, the total discharge amount in the first erasing discharge and in the second erasing discharge in a discharge cell where the discharge start voltage of the first erasing discharge is relatively high is substantially equal to the total discharge amount in a discharge cell where the discharge start voltage of the first erasing discharge is relatively low.

Therefore, in this exemplary embodiment, even when the discharge start voltages in the first erasing discharge differ between the respective discharge cells and the discharge amounts in the first erasing discharge vary, the occurrence of the second erasing discharge equalizes the total discharge amounts in the first erasing discharge and the second erasing discharge in the respective discharge cells.

The discharge start voltage in each discharge cell varies depending on the pattern of the images having been displayed, and whether or not a discharge has occurred in the surrounding discharge cells. In panel 10 that includes the discharge cells miniaturized in response to higher definition, the discharge start voltage in each discharge cell is more likely to be affected by the above factors.

However, even in such panel 10, this exemplary embodiment can substantially equalize the discharge amounts in the erasing discharge in the respective discharge cells, and properly adjust the wall charge by proper erasing operations. Thus, the initializing operation and the address operation after the erasing operations can be performed in a stable manner.

### (Sub-Period T5)

After erasing ramp voltage L5 has reached Vr2, input terminal IN3 is set to “Lo”. Specifically, the input of constant current into input terminal IN3 is stopped. Thus, the operation of Miller integration circuit 55 is stopped.

Suppose the case where voltage Vr2 is set to 255 (V), for example. In this case, when voltage Vsc is 145 (V), input terminal IN3 is set to “Lo” at the time point when reference electric potential A reaches voltage 110 (V). With this operation, the voltage applied to scan electrode SC1-scan electrode SCn stops to rise at the time point when the voltage reaches 255 (V), where voltage 110 (V) of reference electric potential A is superimposed on 145 (V) of voltage Vsc. Thus, voltage Vr2 of erasing ramp voltage L5 is 255 (V).

In sub-period T5, switching element QH1-switching element QHn and switching element QL1-switching element QLn are kept in a state same as that in sub-period T4. Though not shown, the clamp circuit of sustain pulse generation circuit 50 sets reference electric potential A to voltage 0 (V). Since the voltage applied to scan electrode SC 1-scan electrode SCn is a voltage where voltage Vsc is superimposed on reference electric potential A, this operation lowers the voltage applied to scan electrode SC1-scan electrode SCn to voltage Vsc.

### (Sub-Period T6)

In sub-period T6, though not shown, the clamp circuit of sustain pulse generation circuit 50 keeps reference electric potential A at voltage 0 (V). Switching element QH1-switching element QHn are set to OFF, and switching element QL1-switching element QLn are set to ON. With these operations, the voltage of scan electrode SC1-scan electrode SCn is lowered to voltage 0 (V).

### (Sub-Period T7)

In sub-period T7, i.e. a selective initializing period, switching element QH1-switching element QHn and switching element QL1-switching element QLn are kept in a state same as that in sub-period T6. Though not shown, switching element Q4 is set to OFF so as to electrically separate Miller integration circuit 53, Miller integration circuit 55, and sustain pulse generation circuit 50 from reference electric potential A.

Next, input terminal IN2 of Miller integration circuit 54 for generating down-ramp voltage L4 is set to “Hi”. Specifically, a predetermined constant current is input into input terminal IN2. Then, a constant current flows toward capacitor C2, and the drain voltage of switching element Q2 starts to fall in a ramp form. The output voltage of scan electrode driver circuit 43 starts to fall toward negative voltage V14 in a ramp form. This voltage drop continues while input terminal IN2 is at “Hi” or until reference electric potential A reaches voltage Va.

At this time, the constant current to be input into input terminal IN2 is generated such that the gradient of the ramp waveform voltage is at a desired value (−2.5 V/μsec, for example). Thus, down-ramp voltage L4, which falls from voltage 0 (V) as the base electric potential toward negative voltage V14, is generated and applied to scan electrode SC1-scan electrode SCn.

After down-ramp voltage L4 has reached negative voltage V14, input terminal IN2 is set to “Lo”. Specifically, the input of the constant current into input terminal IN2 is stopped. Thus, the operation of Miller integration circuit 54 is stopped. Though not shown, switching element Q4 is set to ON and the clamp circuit of the sustain pulse generation circuit connects reference electric potential A to 0 (V). This operation raises the voltage of scan electrode SC1-scan electrode SCn to voltage 0 (V) as the base electric potential.

A description for the operation of scan electrode driver circuit 43 when down-ramp voltage L2 is generated in subfield SF1 is omitted. The operation of generating down-ramp voltage L2 is substantially the same as the operation of generating down-ramp voltage L4 shown in FIG. 6.

A detailed description for the operation of scan electrode driver circuit 43 when up-ramp voltage L1 is generated in subfield SF1 is also omitted. When up-ramp voltage L1 is generated, switching element Q6 is set to OFF so as to electrically separate Miller integration circuit 55 from reference electric potential A. Switching element QH1-switching element QHn are set to ON, and switching element QL1-switching element QLn are set to OFF. Thereby, a voltage where voltage Vsc is superimposed on reference electric potential A is applied to scan electrode SC1-scan electrode SCn. Thereafter, Miller integration circuit 53 is operated so as to generate up-ramp voltage L1. The procedure for operating Miller integration circuit 53 is substantially similar to that when Miller integration circuit 55 is operated.

In this exemplary embodiment, as described above, the respective voltage values are set such that voltage Vsc≦voltage Vers<voltage Vr2. This is for the following reason. If voltage Vr2 is lower than voltage Vsc, the second discharge does not occur. If voltage Vers is lower than voltage Vsc, a strong discharge occurs in the discharge cells at the timing when voltage Vsc is applied to scan electrode SC1-scan electrode SCn in sub-period T3. This strong discharge excessively erases the wall charge in the discharge cells, thus causing a possibility that the discharge does not occur normally after this strong discharge.

This exemplary embodiment can provide an advantage of reducing the amplitude of the address pulse necessary for causing a stable address discharge in the address periods.

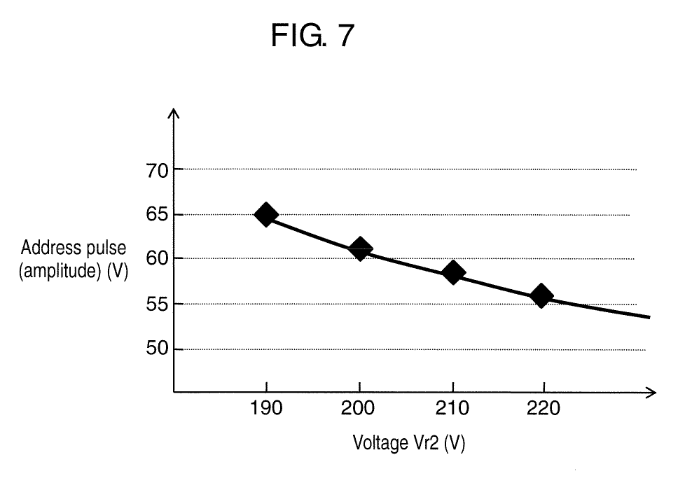

FIG. 7 is a characteristic chart showing the relation between voltage Vr2 and an address pulse (amplitude) in accordance with the exemplary embodiment of the present invention. With reference to FIG. 7, the horizontal axis shows voltage Vr2, and the vertical axis shows the magnitude of an address pulse (amplitude) necessary for causing a stable address discharge.

In the experiments conducted to obtain the characteristic shown in FIG. 7, voltage Vers is set to voltage 190 (V). Therefore, the magnitude of the address pulse (amplitude) obtained when voltage Vr2 is voltage 190 (V) in FIG. 7 is a measurement result without generation of erasing ramp voltage L5.

As shown in FIG. 7, increasing voltage Vr2 can reduce the magnitude of the address pulse (amplitude) necessary for causing a stable address discharge. According to the experimental results of FIG. 7, for example, the magnitude of the address pulse (amplitude) when voltage Vr2 is voltage 190 (V) is approximately 65 (V), and the magnitude of the address pulse (amplitude) when voltage Vr2 is voltage 220 (V) is approximately 56 (V). This shows that in the plasma display apparatus for use in the experiments, setting voltage Vr2 to voltage 220 (V) can make the address pulse (amplitude) approximately 9 (V) smaller than that when voltage Vr2 is voltage 190 (V).

It is considered that the above advantage can be obtained for the following reason. Even if the discharge start voltages in the first erasing discharge are different between the discharge cells and the discharge amounts in the first erasing discharge vary, the occurrence of the second erasing discharge in addition to the first erasing discharge can substantially equalize the total discharge amounts in the first erasing discharge and the second erasing discharge in the respective discharge cells. This can stabilize the initializing operation and the address operation after the erasing operations.

Therefore, if it is intended only to reduce the magnitude of the address pulse (amplitude) necessary for causing a stable address discharge, the only requirement is to set voltage Vr2 to a higher voltage value. However, if voltage Vr2 is set to a higher value, an erasing discharge can occur in some discharge cells having undergone no sustain discharge.

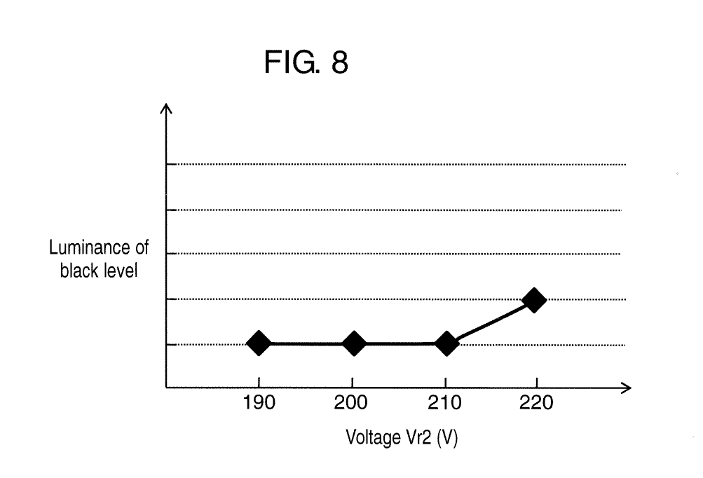

FIG. 8 is a characteristic chart showing the relation between voltage Vr2 and a luminance of black level in accordance with the exemplary embodiment of the present invention. In FIG. 8, the horizontal axis shows voltage Vr2 and the vertical axis shows the brightness of the luminance of black level.

In the experiments conducted to obtain the characteristic shown in FIG. 8, voltage Vers is set to voltage 190 (V). Therefore, the luminance of black level obtained when voltage Vr2 is voltage 190 (V) in FIG. 8 is a measurement result without generation of erasing ramp voltage L5.

According to the experimental results of FIG. 8, the luminance of black level does not change when voltage Vr2 is voltage 210 (V) or lower, but increases when voltage Vr2 is voltage 220 (V). This shows that in the plasma display apparatus for use in the experiments, an erasing discharge occurs in some discharge cells having undergone no sustain discharge when voltage Vr2 is set to voltage 220 (V).

If an erasing discharge occurs in some discharge cells having undergone no sustain discharge, the luminance of the discharge cells displaying low gradations increases and this impairs the contrast of the image displayed on panel 10.

For this reason, in order to prevent an erasing discharge from occurring erroneously (erroneous occurrence) in the plasma display apparatus for use in the experiments, preferably, voltage Vr2 is set to voltage 210 (V) or lower.

That is, in the plasma display apparatus for use in the experiments, setting voltage Vr2 to voltage 210 (V) can prevent the erroneous occurrence of the erasing discharge while reducing the magnitude of the address pulse (amplitude) necessary for causing a stable address discharge. Thereby, an image of excellent contrast can be displayed on the panel.

As described above, it is preferable to set voltage Vr2 in consideration of the following two points: reducing the magnitude of an address pulse (amplitude) necessary for causing a stable address discharge as described with reference to FIG. 7; and preventing erroneous occurrence of the erasing discharge as described with reference to FIG. 8. This setting can prevent erroneous occurrence of the erasing discharge while reducing the magnitude of the address pulse (amplitude) necessary for causing a stable address discharge. Thereby, an image of excellent contrast can be displayed on the panel.

As described above, in this exemplary embodiment, in the last part of each sustain period after generation of sustain pulses has been completed, the following operations are performed. Scan electrode SC1-scan electrode SCn are applied with a first ramp waveform voltage that rises from the base electric potential to a first electric potential. After the first ramp waveform voltage has reached the first electric potential, the electric potential of scan electrode SC1-scan electrode SCn is set to the base electric potential temporarily. Subsequently, the electric potential of scan electrode SC1-scan electrode SCn is changed to a second electric potential. Subsequently, scan electrode SC1-scan electrode SCn are applied with a second ramp waveform voltage that rises from the second electric potential to a third electric potential.

That is, in the above description, in the last part of each sustain period after generation of sustain pulses has been completed, the following operations are performed. Scan electrode SC1-scan electrode SCn are applied with erasing ramp voltage L3, which rises from voltage 0 (V) to voltage Vers. Subsequently, the electric potential of scan electrode SC1-scan electrode SCn is set to the base electric potential. Subsequently, scan electrode SC1-scan electrode SCn are applied with voltage Vsc. Subsequently, scan electrode SC1-scan electrode SCn are applied with erasing ramp voltage L5, which rises from voltage Vsc to voltage Vr2.

In this exemplary embodiment, the second electric potential is set to an electric potential equal to or lower than the first electric potential, and the third electric potential is set to an electric potential higher than the first electric potential.

That is, in the above description, voltage Vsc≦voltage Vers<voltage Vr2.

With this setting, even when the discharge start voltages in the first erasing discharge differ between the respective discharge cells and the discharge amounts in the first erasing discharge vary, the occurrence of the second erasing discharge can substantially equalize the total discharge amounts in the first erasing discharge and the second erasing discharge in the respective discharge cells. Therefore, even in panel 10 that includes the discharge cells miniaturized in response to higher definition, the discharge amounts in the erasing discharge in the respective discharge cells can be substantially equalized to each other, and the wall charge can be adjusted properly by the proper erasing operations. Thus, the initializing operation and the address operation after the erasing operations can be performed in a stable manner.

Further, setting voltage Vr2 to an appropriate voltage value can reduce the magnitude of the address pulse (amplitude) necessary for causing a stable address discharge while an image of excellent contrast is displayed on panel 10. Thereby, the image display quality in the plasma display apparatus can be enhanced.

In the structure described in this exemplary embodiment, the base electric potential is 0 (V). However, in the present invention, the base electric potential is not limited to 0 (V). In the present invention, the base electric potential is a reference electric potential when driving voltages are applied to panel 10.

In the structure described in this exemplary embodiment, after the first ramp waveform voltage has reached the first electric potential, the electric potential of scan electrode SC1-scan electrode SCn is lowered to the base electric potential temporarily. However, the present invention is not limited to this structure. The following structure, for example, can also be used. After the first ramp waveform voltage has reached the first electric potential, the electric potential of scan electrode SC1-scan electrode SCn is lowered from the first electric potential to the second electric potential, and thereafter these electrodes are applied with the second ramp waveform voltage.

The all-cell initializing waveform in the present invention is not limited to the waveform shown in this exemplary embodiment. Any waveform can be used as the all-cell initializing waveform as long as the waveform causes an initializing discharge in the discharge cells regardless of the operation in the immediately preceding subfield.

In the structure described in this exemplary embodiment, the selective initializing waveform (down-ramp voltage L4) is generated with a single gradient in the selective initializing period. However, in the present invention, the selective initializing waveform is not limited to this waveform shape. Any waveform can be used as the selective initializing waveform as long as the waveform causes an initializing discharge only in the discharge cells having undergone a sustain discharge in the immediately preceding sustain period. For example, the selective initializing waveform may be generated so as to be divided into a plurality of sub-periods having different gradients.

For example, a selective initializing waveform may be generated such that the voltage applied to scan electrodes 22 changes in the following manner. Before the occurrence of discharge (e.g. voltage 0 (V) to −100 (V)), the applied voltage is lowered with a relatively steep gradient (−8 V/μsec, for example). Thereafter (e.g. −100 (V) to −135 (V)), the applied voltage is lowered with a rather gentle gradient (−2.5 V/μsec, for example). At last (e.g. −135 (V) to −160 (V)), the applied voltage is lowered with a relatively gentle gradient (−1.0 V/μsec, for example). Also with such a structure, the advantage similar to the above can be obtained. This structure can provide another advantage of making the time period taken to generate the selective initializing waveform shorter than that when down-ramp voltage L4 is generated.

In the structure of this exemplary embodiment, the first subfield (subfield SF1) of one field is an all-cell initializing subfield, and the subfields thereafter (e.g. subfield SF2-subfield SF8) are selective initializing subfields. However, the present invention is not limited to this structure. The all-cell initializing subfield may be subfield SF2 or a subfield thereafter.

The timing chart of FIG. 6 only shows an example of the exemplary embodiment of the present invention. The present invention is not limited to this timing chart.

In the example of the structure described in this exemplary embodiment, one field is formed of eight subfields. However, in the present invention, the number of subfields forming one field is not limited to the above number. For example, setting the number of subfields greater than eight can further increase the number of gradations displayable on panel 10.

In the examples described in this exemplary embodiment, the respective luminance weights of subfield SF1-subfield SF8 are set to powers of “2”, i.e. 1, 2, 4, 8, 16, 32, 64, and 128. However, the luminance weights set to the respective subfields are not limited to the above numerical values. Setting the luminance weights to 1, 2, 3, 7, 12, 31, 50, and 98, for example, gives redundancy to the combination of the subfields determining gradations and thereby allows the coding with which the occurrence of a moving image false contour is suppressed. The number of subfields forming one field, the luminance weights of the respective subfields, or the like is set appropriately for the characteristics of panel 10 and the specifications of plasma display apparatus 1, for example.

Each circuit block shown in this exemplary embodiment of the present invention may be formed as an electric circuit that performs each operation shown in the exemplary embodiment, or formed of a microcomputer, for example, programmed so as to perform the similar operations.

In the examples described in this exemplary embodiment, one pixel is formed of discharge cells of R, G, and B three colors. Also a panel that includes pixels, each formed of discharge cells of four or more colors, can use the configuration shown in this exemplary embodiment and provide the same advantage.

The above driver circuit only shows an example and the configuration of the driver circuit is not limited to the above configuration.

The exemplary embodiment of the present invention can be applied to a driving method for a panel, which is so-called two-phase driving. In the two-phase driving, scan electrode SC1-scan electrode SCn are divided into a first scan electrode group and a second scan electrode group. Further, each address period is formed of two address periods: a first address period where a scan pulse is applied to each of the scan electrodes belonging to the first scan electrode group; and a second address period where a scan pulse is applied to each of the scan electrodes belonging to the second scan electrode group.

The exemplary embodiment of the present invention is also effective in a panel having an electrode structure where a scan electrode is adjacent to a scan electrode and a sustain electrode is adjacent to a sustain electrode. That is, the electrodes are arranged on the front substrate in the following order: . . . , a scan electrode, a scan electrode, a sustain electrode, a sustain electrode, a scan electrode, a scan electrode . . . .

The specific numerical values, such as the gradients of ramp waveform voltages, i.e. up-ramp voltage L1, down-ramp voltage L2, erasing ramp voltage L3, down-ramp voltage L4, and erasing ramp voltage L5, in this exemplary embodiment are set based on the characteristics of panel 10 that has a 50-inch screen and 1024 display electrode pairs 24, and only show examples in the exemplary embodiment. The present invention is not limited to these numerical values. Preferably, each numerical value is set optimally for the characteristics of the panel, the specifications of the plasma display apparatus, or the like. Variations are allowed for each numerical value within the range in which the above advantage can be obtained. The number of subfields, the luminance weights of the respective subfields, or the like is not limited to the values shown in the exemplary embodiment of the present invention. The subfield structure may be switched in response to an image signal, for example.

### INDUSTRIAL APPLICABILITY

The present invention can enhance image display quality by properly adjusting the wall charge and thus allowing a stable address operation even in a high-definition panel. Thus, the present invention is useful as a plasma display apparatus and a driving method for a panel.

### REFERENCE MARKS IN THE DRAWINGS

1 Plasma display apparatus
10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
41 Image signal processing circuit
42 Data electrode driver circuit
43 Scan electrode driver circuit
44 Sustain electrode driver circuit
45 Control signal generation circuit
50 Sustain pulse generation circuit
51 Initializing waveform generation circuit
52 Scan pulse generation circuit
53, 54, 55 Miller integration circuit
Q1, Q2, Q3, Q4, Q5, Q6, QH1-QHn, QL1-QLn Switching element
C1, C2, C3, C31 Capacitor
Di31 Diode
R1, R2, R3 Resistor
L1 Up-ramp voltage
L2, L4 Down-ramp voltage
L3, L5 Erasing ramp voltage

1. A plasma display apparatus comprising:
a plasma display panel including a plurality of scan electrodes; and
a scan electrode driver circuit for generating driving voltages to be used in a subfield method and applying the driving voltages to the scan electrodes, the subfield method displaying gradations in a manner such that a plurality of subfields, each having an initializing period, an address period, and a sustain period, is set in one field,
wherein, at an end of each sustain period, the scan electrode driver circuit applies a first ramp waveform voltage, rising from a base electric potential to a first electric potential, to the scan electrodes, subsequently sets an electric potential of the scan electrodes to a second electric potential equal to or lower than the first electric potential, and subsequently applies a second ramp waveform voltage, rising from the second electric potential to a third electric potential higher than the first electric potential, to the scan electrodes.

2. The plasma display apparatus of claim 1, wherein, after the first ramp waveform voltage has reached the first electric potential, the scan electrode driver circuit sets the electric potential of the scan electrodes to the base electric potential temporarily, thereafter changes the electric potential of the scan electrodes from the base electric potential to the second electric potential, and subsequently applies the second ramp waveform voltage, rising from the second electric potential to the third electric potential, to the scan electrodes.

3. A driving method for a plasma display panel,
the plasma display panel including a plurality of scan electrodes,
the plasma display panel being driven by a subfield method for displaying gradations in a manner such that a plurality of subfields, each having an initializing period, an address period, and a sustain period, is set in one field,
the driving method comprising:
at an end of each sustain period, applying a first ramp waveform voltage, rising from a base electric potential to a first electric potential, to the scan electrodes;
subsequently, setting an electric potential of the scan electrodes to a second electric potential equal to or lower than the first electric potential; and
subsequently, applying a second ramp waveform voltage, rising from the second electric potential to a third electric potential higher than the first electric potential, to the scan electrodes.

4. The driving method for the plasma display panel of claim 3, wherein
after the first ramp waveform voltage has reached the first electric potential, setting the electric potential of the scan electrodes to the base electric potential temporarily;
thereafter, changing the electric potential of the scan electrodes from the base electric potential to the second electric potential; and
subsequently, applying the second ramp waveform voltage rising from the second electric potential to the third electric potential to the scan electrodes.
